(19) United States
(12) Patent Application Publication
(10) Pub. No.: US 2012/0061546 A1
(43) Pub. Date: Mar. 15, 2012

(54) Mouse Platform with Warning Track

(76) Inventor: Lawrence E. Hamilton, Mt. Prospect, IL (US)

(21) Appl. No.: 13/229,595

(22) Filed: Sep. 9, 2011

Related U.S. Application Data
(60) Provisional application No. 61/381,820, filed on Sep. 10, 2010.

(51) Int. Cl. G06F 3/039

(52) U.S. Cl. 248/349.1; 248/346.5

(57) ABSTRACT

A mouse pad, keyboard tray, or other surface for use with a computer pointing device, the surface of the mouse pad, keyboard tray, or other surface including a raised bump, barrier, or warning structure about a central area to allow the user to know that the perimeter or edge of the mouse pad or surface is near. The bump, barrier, or warning structure may be located at the perimeter of the surface or displaced from the perimeter allowing the mouse or other pointing device to run over the raised bump, barrier, or warning structure and still be supported by the surface on both sides of the bump, barrier, or warning structure. The bump, barrier, or warning structure also prevents the mouse or computer pointing device from sliding off of the surface when the keyboard tray is at an angle of up to 15 degrees with respect to the ground.

### CROSS-REFERENCE TO RELATED APPLICATIONS

This application claims priority to U.S. Provisional Application 61/381,820.

### FIELD OF THE INVENTION

The invention relates to mouse pads and surfaces for use with computer mice or pointing devices. The invention also relates to adjustable keyboard trays.

### BACKGROUND OF THE INVENTION

Users of computer mice have employed mouse pads on desktops to provide a mouseing surface on which to operate the computer mouse. The mouse pad typically provides a uniform and flat surface that allows the mouse ball to experience uniform and sufficient traction, or in the case of optical mice, provides a surface of uniform texture and reflectivity. The pad may also include a wrist rest that is elevated above the mouseing surface to increase the users comfort. The wrist rest is located on one side of the mouse pad and is approximately 0.5 to 1.0 inches in height above the mouseing surface.

The mouse pads of the prior art are typically a thin rectangle of material, such as plastic, neoprene, rubber, typically faced with a fabric surface. The thickness of the pad can vary, but it typically is approximately 0.25 inches thick. This thickness elevates the mouseing surface above the user's desktop. Thus, if the user moves the mouse too far, the feet or pads on the bottom of the mouse may run off the edge of the mouse pad, causing the user to experience increased friction as the bottom of the mouse contacts the surface of the mouse pad. The mouse may also tilt as it goes over the edge, causing the mouse ball to lose traction and possibly stop functioning to move the screen cursor, or move the cursor in a manner not intended by the user. If the mouse is an optical mouse, the uneven transition may cause the cursor to behave in a manner not intended by the user. Thus it is desirous to produce a mouse pad that warns the user that the edge of the mouse pad is approaching. It is also desirous to allow the user to easily overcome the structure providing the warning so that the user may continue using the mouse. It is a purpose of the invention to produce a mouse pad or other mouseing surface that provides a warning to the user that the edge of the mouse pad is being approached by the mouse, yet allows the user to mouse over the warning structure or barrier if so desired.

Adjustable keyboard trays have also become popular. The trays allow the keyboard to be suspended at different angles from below the desk. Some of the trays include space or a platform for the computer mouse. However, because the trays are adjustable in the angle with reference to the desk surface, the tray or mouse platform may be at an incline with respect to the ground. In such instances, a mouse located on the tray or platform may roll off of the tray or platform. It is an object of the invention to provide a structure or barrier to prevent the mouse from rolling off the inclined tray or platform, yet still allow the user to move the mouse over the structure during use of the mouse. Thus, the warning structure of the invention also may perform the function of retaining the mouse on the mouse platform or mouseing area of a keyboard tray or platform.

### SUMMARY OF THE INVENTION

The mouseing surface disclosed herein includes a warning structure such as a slight bump, set back slightly from the perimeter of the mouseing surface. The warning structure may be at the perimeter of the mouseing surface, pad, or platform, but is preferably displaced there from. The displacement allows for a small border region so that the user may still have support for the mouse feet for a short distance after a mouse foot is run over the warning structure or barrier.

The warning structure is of such a height above the mouseing surface to allow the body of the mouse to pass over without contacting the warning structure, but to interfere with the feet of the mouse. When used with keyboard trays, the warning structure should stop the mouse from going over the warning structure or bump when the mouseing surface is inclined 15 degrees, so that the mouse does not fall off of the mouseing surface and fall to the floor.

The warning structure should be constructed of a material that will offer some frictional resistance different than that of the mouseing surface. Thus, it is preferred that the warning structure be made of a material different than the material of the mouseing surface. This greater or lesser resistance will provide some tactile feel to the user as the user moves the mouse over the warning structure.

The warning structure can produce the tactile feel by all or any one of three mechanisms.

The bump may create softness or give in the surface if the warning structure is created out of a material that is softer than that of the mouseing surface. As the mouse foot encounters the raised warning structure, the warning structure will give, allowing the user tactile input that the structure has been reached, but also allowing the user to easily pass over. The warning structure may also provide a tactile input to the user by the slight bump raising the mouse upwards as the user passes the mouse over the warning structure. Frictional resistance as the mouse feet contact the warning structure may also provide a tactile input to the user. In most cases, it will be of benefit to have a frictional resistance that is greater than that of the mouseing surface. In such an embodiment where the warning structure is hard and does not give or compress much, it may be of benefit to have the warning structure have a frictional resistance that is less than that of the mouseing surface in order to allow the mouse to pass over since the warning structure may not have as much give. However, the lesser frictional resistance may be detrimental to the warning structure containing the mouse on a sloped surface. A greater resistance will also resist the mouse foot from going over the warning structure when the mouse is not being used, which may occur when the mouseing surface is set at an incline, as might be the case if the mouseing surface is on an angled keyboard tray. One skilled in the art will recognize that the warning structure can be constructed with different combinations of these properties to achieve the desired result for a specific application.

It is also of a benefit, although not necessary, to construct the warning structure with a material that has some give, so that the warning structure depresses downward as the mouse foot is moved over the warning structure by the user operating the mouse. However, it is preferable that the warning structure exhibit little or no give or depression when the mouse encounters the warning structure when not being used, as when it slides down the inclined mouseing surface that might be present on a keyboard tray. This in contrast to when the mouse is being used, when downward give is desired.

The warning structure can be rubber gasket material placed in a channel in the mouseing surface so that a portion, normally 0.015 to 0.025 inches, protrudes above the mouseing surface. It is preferable that the exposed warning structure have a profile in cross section that allows the mouse foot to ride up and over the earning structure when the mouse is being used. Thus it is preferred that the warning structure profile have a slope rather than a hard or abrupt edge that may catch the mouse foot and unduly inhibit movement of the mouse. In practice, an arcuate profile is preferred. The profile may be symmetrical, but need not be so.

The warning structure disclosed herein may be incorporated in a desk surface, a keyboard tray, or on a mouse pad such as those used on a desk top. In any of the applications, the warning structure may be discontinuous, and as it may be desirable or unnecessary to have the warning structure on all side of the mouseing surface.

### BRIEF DESCRIPTION OF THE DRAWINGS

FIG. 1 is a perspective view of a mouse pad having a warning structure.

FIG. 1A is a cross sectional lavational view of the mouse pad of FIG. 1.

FIG. 2 is a perspective view of a mouse pad having a warning structure than completely bounds the central mouseing area of the mouse pad.

FIG. 2A is a cross sectional view of the mouse pad of FIG. 2.

FIG. 3 is a perspective view of a keyboard tray attached to a desktop, the keyboard tray including mouseing area having a warning structure.

FIG. 3A is a cross sectional elevational view of the keyboard tray of FIG. 3, showing the range of tilt of 15 degrees of the keyboard platform.

FIG. 4 is a top view of the keyboard tray.

FIG. 5 is a detail view of the mouseing area of the keyboard tray of FIG. 3.

FIG. 5A is a cross sectional elevational view of the keyboard tray of FIG. 5.

FIG. 6 is an alternate construction for the mouseing area of a keyboard tray.

FIG. 6A is a cross sectional elevational view of the keyboard tray of FIG. 6.

FIG. 7A is a cross sectional elevational view of e mouseing area of a keyboard tray including an alternate profile for the warning structure.

FIG. 7B is a cross sectional elevational view of the mouseing area of a keyboard tray including an alternate profile for the warning structure.

FIG. 7C is a cross sectional elevational view of the mouseing area of a keyboard tray including an alternate profile for the warning structure.

FIG. 8 is a perspective view of an alternate embodiment of a keyboard tray attached to a desktop, the keyboard tray having a separate and independently angled mouse platform.

FIG. 8A is a cross sectional elevational view of the keyboard tray of FIG. 8, showing the range of tilt of 15 degrees of the keyboard platform.

FIG. 8B is a cross sectional elevational view of the mouse platform of the keyboard tray of FIG. 8, showing the range of tilt of 30 degrees of the mouse platform.

FIG. 9 is a top view of the keyboard tray of FIG. 8.

FIG. 9A is a cross sectional elevational view of the mouse platform of FIG. 9.

### DETAILED DESCRIPTION OF THE PREFERRED EMBODIMENT

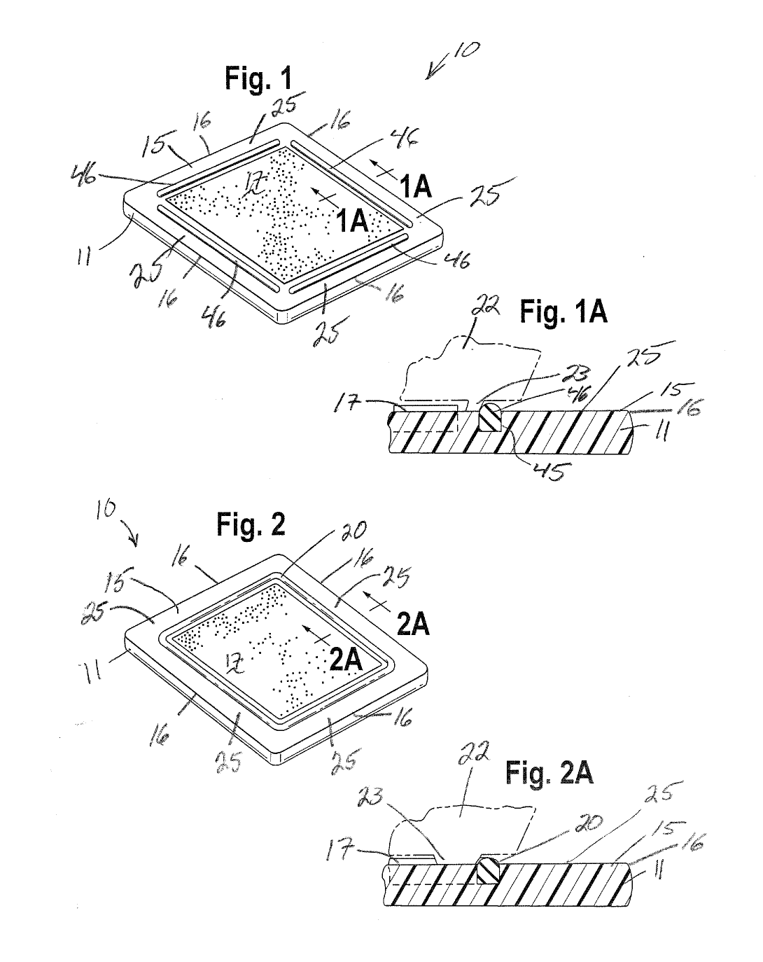

With reference to the figures, the most basic embodiment of the invention is for a desktop mouse pad 10 for use with a computer mouse or other computer interface, as shown in FIGS. 1 and 2. The mouse pad 10 includes a platform 11 having a mouseing surface 15 and a perimeter 16. The mouseing surface 15 includes a central mouseing area 17. The central mouseing area is generally planar. A warning structure 20 is located between the central mouseing area 17 and the perimeter 16.

In the embodiment shown in FIG. 2, the warning structure 20 is a bump surrounding the central mouseing area 17. In the preferred embodiment, the warning structure 20 extends above the mouseing surface 15 approximately 0.015 to 0.025 inches. However, on skilled in the art will recognize that the warning structure 20 may extend more or less, depending upon the thickness of the foot 22 of the mouse 23 intended to be used with the mouse pad 10. It is preferred that the warning structure 20 extend no more than the distance the mouse foot elevates the mouse from the mouseing surface 15.

The warning structure 20 can be constructed in a number of ways. In the embodiment shown in FIG. 2, and shown in further detail in FIG. 9A, the warning structure 20 is created by placing a gasket, such as a rubber o-ring , in a channel 45 that extends below the mouseing surface 15. The gasket is preferably 0.116 inches in diameter and is placed in a channel 45 that is approximately 0.1 inches deep and 0.1 inches wide. This allows the gasket to protrude from the mouseing surface 15 to create a bump with an arcuate profile. The gasket may be secured in the channel 45 by adhesive.

The width of the warning structure 20 in the most preferred embodiment is 0.1 inches.

One skilled in the art will recognize that other widths can be used, however wider width may impede movement of the mouse 22 too greatly.

As shown in FIG. 2, the gasket is continuous so that the warning structure 20 is constructed of one o-ring and encloses or encircles the central mouseing are 17. However, strips 46 of gasket material can be utilized as shown in FIG. 1. In such an embodiment, the strips 46 are generally set parallel to the perimeter 16 of the mouse pad 10. In such an embodiment, the strips are set in a channel 45 to create the bump above the mouseing surface 15 to form the warning structure 20. It is easily recognizable that the strips 46 are the functional equivalent of the continuous o-ring shown in FIG. 2, and that other structures may be used to create the bump or warning structure that protrudes above the mouseing surface 15 to interact with the mouse foot 23, but not the body of the mouse 22.

In the preferred embodiment, the warning structure 20 is made of Buna-N elastomer or butyl rubber having a durometer number of approximately 50 on a Shore A scale. One skilled in the art will recognize that other materials can be used.

The warning structure 20 is preferably located a distance from the perimeter 16 of the platform 11, thereby creating a border area 25. The hoarder area 25 allows the user to overrun the warning structure 20 and still have support for the mouse between the warning structure 20 and the perimeter 16. In the embodiment shown in FIGS. 5 and 7A-7C, the warning structure 20 is located at or very near the perimeter 16 of the mouse pad 10, and hence, there is little or no border area 25 that the mouse foot can rest on once the mouse foot overruns the warning structure 20. In FIGS. 6, and 6A, the warning structure 20 is located at the perimeter 16, and no support is offered to the mouse should the mouse run over and beyond the warning structure 20.

Other constructions of the warning structure 20 can be made consistent with the teachings above. The warning structure 20 can be constructed of molded or extruded plastic, elastomer, or other material that may create a bump above the mouseing surface. In the preferred embodiment, it is preferred that the material offer some flex, give, or yield in the downward direction as the mouse foot goes over the warning structure 20.

As discussed in the summary of the invention, the warning structure may have a combination of properties, so in some instances flex, give, or yield may not be desired. In an alternate embodiment, it is desired that the warning structure 20 be made of a material with no perceptible yield, but decreased friction with respect to the mouseing surface 15. In such an embodiment, it is preferred that the profile of the waning structure 20 be a shallow arc protruding upwards. A shallow arc recess below the mouseing surface may alternately be employed.

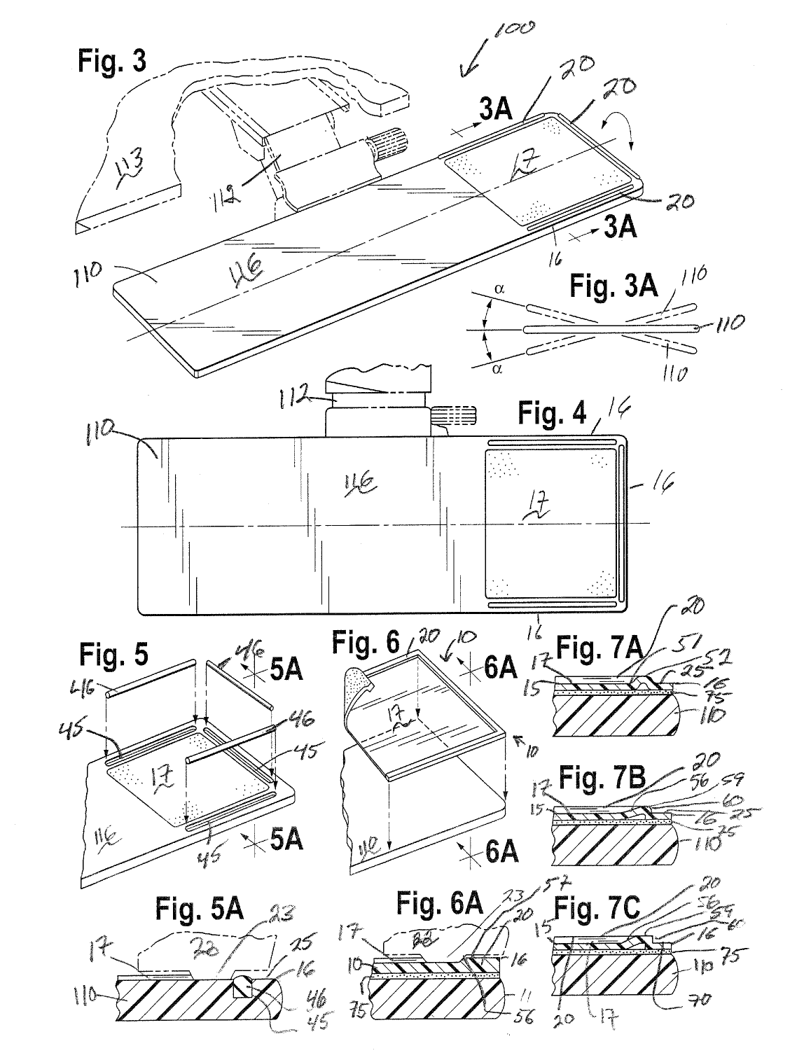

The warning structure of the present invention can be incorporated in to keyboard trays or other support surfaces that are used in conjunction with computer mice. Such embodiment is shown in FIGS. 3, 4, 5, 8, 8A, 8B, and 9. FIG. 3 shows an adjustable keyboard tray 100 that includes a support surface 110 for the keyboard and mouse, and an adjustable arm or strut 112 that allows the support surface 110 to be adjusted both in distance and angle to the desk 113 to which the adjustable arm attaches.

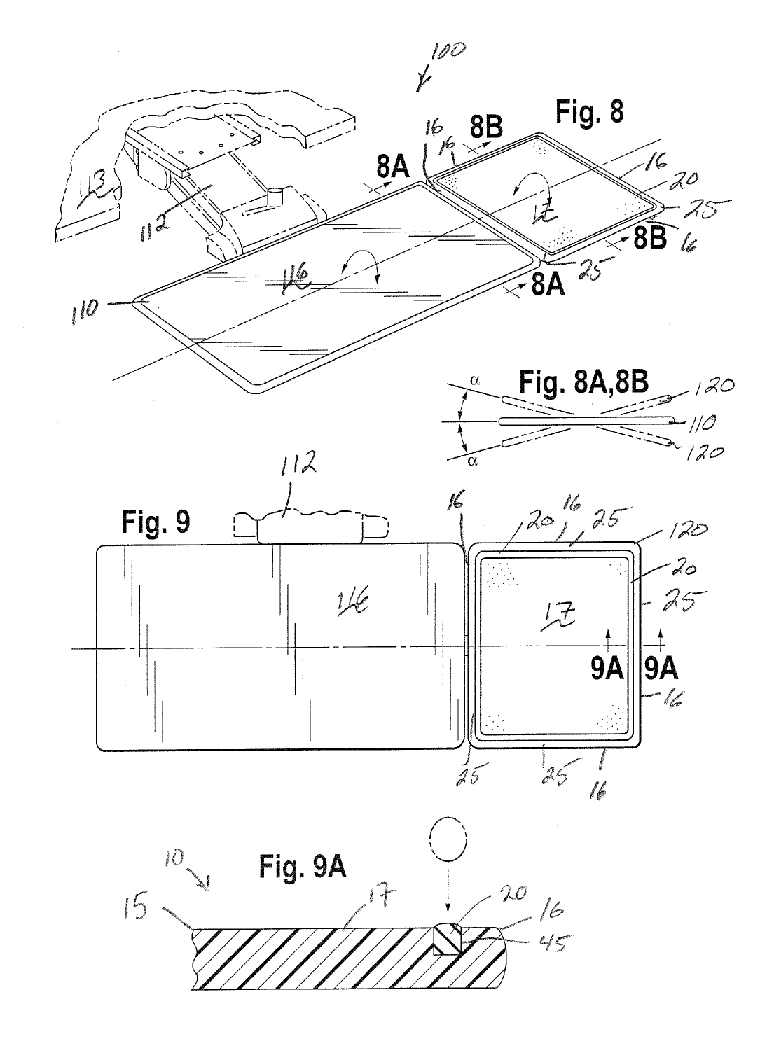

The support surface includes a keyboard area 116 and a mouseing area 17. The mouseing area is bordered by a warning structure 20 as described above. As shown in the figures of the keyboard tray 100, the warning structure 20 used with the support surface 110 does not need to completely encircle the mouseing area 17, although it could, as shown in the embodiment shown in FIG. 8. As shown in FIGS. 3 and 4, the warning structure 20 is present on only three sides of the rectangular mouseing area 117. One side facing the keyboard area 116 is left open as the warning structure is not needed, since there is no perimeter for the mouse to fall off of on that side. As shown in FIG. 5, the warning structure 20 is formed by inserting strips 46 of elastomer, rubber, or gasket material into channels 45 in the surface of the support surface 110.

As shown in FIGS. 8 and 9, the keyboard tray 100 may include a mouseing area 17 that is on a separate mouse platform 120 from that of the keyboard area 116. This arrangement allows the mouseing area to be placed at an angle with respect to the keyboard area 116. The angle alpha is generally plus or minus 15 degrees. The warning structure 20 is constructed so that the warning structure will retain the mouse on the mouseing area or mouse platform when the mouse platform is angled from 0 to 15 degrees relative to the ground, yet still allow the user to push the mouse over the warning structure 20 when using the mouse. In the preferred embodiment, if the mouseing surface 15 is placed at an angle of 15 degrees relative to the ground, the warning structure 20 will prevent a free sliding or falling mouse from sliding off the mouseing surface 15 when the mouse is allowed to free slide from one perimeter 16 of the mouseing surface 15 towards another perimeter 16.

The warning structure 20 may be created in other ways and with profiles other than an arc. Such alternate profiles and constructions can be utilized for a standalone mouse pad 10, or for use with keyboard trays. As shown in FIGS. 6, 6A, and FIGS. 7A-7C the warning structure 20 and the mouseing area 17 and may be created by placing or attaching a thin mouse pad as described above to the support surface 110. The mouse pad 10 may be attached with adhesive 75.

The profile of the warning structure 20 or bump that is above the mouseing surface 15 is preferably arcuate, however other profiles, as shown in FIGS. 6A, and 7A-7C can be utilized. It is preferred, although not necessary, that the profile have some smooth transition from the level of the mouseing surface 15 to the maximum height, and back down again. It is not necessary that the transition be constant, and it may vary over the horizontal distance traveled. For instance, the profile may exhibit an arc of a first radius 51 linked to an arc of a second radius 52 to form the profile to the maximum height or crown. The first arc 51 can also be concave and the second arc 52 convex.

In FIG. 6, it is shown that the profile of the warning structure 20 is an angled ramp portion 56 that transitions from the level of the mouseing surface 15 to a raised platform 57 having a generally planar surface. The raised platform 57 may extend to the perimeter 16.

FIG. 7B shows a profile having ramp portion 56 transitioning to a crown 59, and then transitioning to a drop off 60. The drop off may occur at the perimeter, or transition to an additional planar area, preferably at the level of the mouseing surface 15.

FIG. 7C shows a warning structure 20 profile having a ramp portion 56 transitioning to a flat crown 59 that transitions to a sharp drop off 60. The drop off 60 transitions to a planar area 70 that is preferably, though not necessarily at the level of the mouseing surface 15, thus giving additional mouseing area between the warning structure 20 and the perimeter 16.

Such complex profiles as shown in FIGS. 6A and 7A-7C are best formed by constructions other than an o ring gasket. The warning structure can be formed by molding the warning structure as part of the surface of the mouse pad 10. In other embodiments, the warning structure 20 can be attached to the surface of the mouse pad by a suitable adhesive.

The embodiments described herein are merely examples, and are not meant to limit the scope of the invention.

I claim:

1. A mouse pad having a mouseing surface for operating a computer mouse having feet that have a height to place the mouse at a height above the mouseing surface, the mouse pad further including a perimeter, and a raised surface at the perimeter, the raised surface having a height above the mouseing surface, the height of the raised surface being less than the height of the mouse feet.

2. The mouse pad of claim 1, wherein the mouseing surface has a first coefficient of friction, and the raised surface has a second coefficient of friction.

3. The mouse pad of claim 1, wherein the maximum height of the raised surface is between 0.015 and 0.025 inches above the mouseing surface.

4. The mouse pad of claim 1, wherein the raised surface has an arcuate profile.

5. The mouse pad of claim 1, wherein the mouseing surface has a first coefficient of friction, and the raised surface has a second coefficient of friction.

6. The mouse pad of claim 1 wherein the raised surface is made of a material different than the material of the mouseing surface.

7. A surface for using a computer pointing device, the surface having a perimeter, the surface including an area for operating the pointing device, the area being bounded on at least one side by a raised surface, the raised surface being at a height between 0.015 and 0.025 above the surface, the surface further including a border area located between the raised surface and the perimeter.

8. The surface of claim 7 where the area for operating the pointing device has a first coefficient of friction, and the raised surface has a second coefficient of friction.

9. The surface of claim 7, where the area for operating the pointing device is bounded on three sides by the raised surface.

10. The surface of claim 7 where the raised surface is about 0.1 inches wide.

11. The surface of claim 7 where the raised surface is arcuate in profile.

12. The surface of claim 7 where the area for operating the pointing device and the border area have a first coefficient of friction and the raised surface has a second coefficient of friction.

13. The surface of claim 7 further including a keyboard area for supporting a keyboard, the surface including a mount to allow the surface to be inclined at an angle with respect to ground, the raised surface positioned to prevent a computer pointing device from sliding off the surface when the surface is placed at an angle.

14. The surface of claim 7 wherein the surface has a first coefficient of friction and the raised surface has a second coefficient of friction.

15. A surface for using a computer pointing device, the surface including an area for operating the pointing device, the area substantially enclosed by a warning structure extending above the surface, the warning structure being of a height that a user can move a computer pointing device over the warning structure while operating the computer pointing device and receive a tactile input that the warning structure has been encountered by the pointing device.

16. The surface of claim 15 wherein the warning structure deflects downward when the pointing device is moved over the warning structure.

17. The surface of claim 16 wherein the warning structure is 0.015 to 0.025 inches in height above the surface.

18. The surface of claim 15, where the warning structure has a hardness of approximately 50 on the Shore D scale.

19. The surface of claim 15, where the surface includes a perimeter and a border area, the boarder area located between the perimeter and the warning structure.

20. The surface of claim 19 where the border area and the area for operating the computer pointing device support the computer pointing device when part of the computer pointing device moves beyond the warning structure towards the perimeter.

21. The surface of claim 15 where the warning structure does not allow the computer pointing device to roll off the surface without user input when the surface is angled from 1 to 15 degrees with respect to ground.
